(19) United States
(12) Patent Application Publication
(10) Pub. No.: US 2005/0087263 A1
(43) Pub. Date: Apr. 28, 2005

(54) Tool assembly and method for attaching teeth to a cutter wheel of a tree stump removal machine

(75) Inventor: Lyle J. Clemenson, Brooklyn Park, MN (US)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(73) Assignee: Clemenson Enterprises, Inc.

(21) Appl. No.: 10/694,210

(22) Filed: Oct. 27, 2003

(51) Int. Cl. B27C 1/00; B27C 5/00; B27G 13/00; B27M 1/08; B27L 5/02; B27L 7/00; B27C 9/00; B27L 11/00

(52) U.S. Cl. 144/369; 144/373; 144/162.1; 144/230

(57) ABSTRACT

A tool assembly for attachment to a cutter wheel for use in tree stump removal is described. The assembly includes a tooth and a pocket. The tooth includes a cutting head and a shank depending from the head. The shank includes a first flat opposite a second flat. The pocket defines opposing wheel and exterior faces. A tooth receiving slot is formed in the wheel face and includes a base. In this regard, the tooth shank defines one of a projection and a recess and the pocket defines the other of the projection and the recess. Upon coupling the tooth shank to the tooth receiving slot, substantially an entirety of a peripheral edge of the projection contacts a wall of the recess to resist a torque applied to the cutting head.

### THE FIELD OF THE INVENTION

The present invention relates to a tool assembly attachable to a cutter wheel of a tree stump removal machine. More particularly, it relates to a tool assembly configured to resist torque applied to a cutting tooth otherwise mounted to the cutter wheel.

### BACKGROUND

Tree stump removal machines have been used for decades in the tree service industry to remove tree stumps from the ground. These removal machines generate immense horsepower and have a rotating cutter wheel assembly that is repeatedly positioned onto an exposed section of the tree stump to grind the stump into wood chips for subsequent removal. Such removal machines continue to be the preferred device for removing and recycling tree stumps.

Tree stump removal machines generally consist of a motor that rotates a cutter wheel provided with cutting teeth. The cutting teeth are circumferentially mounted around a periphery of the cutter wheel. In particular, the cutting teeth are removably positioned on opposite sides of the cutter wheel and are held in place by a pocket and bolt/fastener. Over time, the cutting teeth are replaced as they wear. The wear can be due to either a dulling of the cutting surface, a deterioration of the pocket/tooth interface, or a combination of both factors.

With this in mind, a prior art cutter wheel assembly, described in U.S. Pat. No. 4,998,574, is generally illustrated at 10 in FIG. 1. The prior art cutter wheel assembly 10 includes a cutter wheel 12 having teeth 14 each of which is attached about a periphery 16 thereof by a corresponding pocket 18. The combination tooth 14/pocket 18 is referred to herein as a “tool assembly.” Each tooth 14 has a shank 20 that fits within a slot 24 formed in each pocket 18. Further, a recess 22 is formed on the shank 20 of each tooth 14, whereas each pocket 18 forms a pin 26 (one of which is shown in the view of FIG. 1) within each slot 24. The recess 22 and the pin 26 are purposefully configured such that the pin 26 fits loosely within the recess 22 to coarsely align the tooth 14 within the pocket 18. Lastly, a bolt 28 and nut 30 system is provided to fix the combination tooth 14/pocket 18 to opposing sides of the cutter wheel 12.

During a stump removal operation, the stump removal machine (not shown) rotates the cutter wheel 12 in a direction indicated by arrow 32. The teeth 14 intersect and maul the tree stump (not shown) as the cutter wheel 12 is rotated. In this regard, the stump removal machine generates a huge torque created by the force of the teeth 14 cutting into the tree stump. The jarring motion of the teeth 14 contacting the tree stump, and the large torque delivered to the teeth 14, is better illustrated in FIG. 2.

During stump removal, as the tooth 14 contacts the tree stump (not shown), a large torque is delivered to the tooth 14 as indicated proportionately by arrow 42 in FIG. 2. After contact with the tree stump, and especially after contact with a foreign object such as metal (i.e., a nail or chain) in the tree stump, the tooth 14 recoils with a countering torque as indicated by arrow 44. Therefore, the tooth 14 experiences a rocking motion resulting from the cyclical (rotational) cutting of the tooth 14 into the stump. The torque 42 results in forces transmitted down the shank 20 that are delivered to a first forward portion 48 and a first rearward portion 50 of the slot 24. After completion of the cutting motion for each tooth, the countering torque 44 results in forces delivered to a second forward portion 52 and a second rearward portion 54 of the slot 24. Consequently, the torque 42 and the countering torque 44 delivered to the tooth 14 results in large and alternating forces at forward portions 48, 52 and rearward portions 50, 54 of the slot 24. Accordingly, the forward and the rearward portions 48-54 of the slot 24 are cyclically stressed. Significantly, regarding the prior art tooth 14 and pocket 18, the pin 26 is loosely fitted within the recess 22 resulting in a clearance fit between the recess 22 and the pin 26. Hence, the recess 22 and the pin 26 generally align the tooth 14 within the pocket 18; however, the recess 22 and the pin 26 are incapable of mitigating the above-described stress delivered to the slot 24. Over repeated operation cycles, the slot 24 becomes overtly worn such that there is significant, highly undesirable movement of the tooth 14 in both the axial and lateral directions. Movement of the tooth 14 within the pocket 18 can result in the tooth 14 eventually dislodging unexpectedly from the pocket 18, potentially causing bodily harm or damage to the cutter wheel 12. Additionally, movement of the tooth 14 within the pocket 18 can accelerate tooth 14 wear.

Tree stump removal machines are useful tools for the efficient, economic, and environmentally sound practice of extricating tree stumps. Because these immense horsepower machines deliver immense torque to the cutting teeth, the teeth and pockets experience wear that translates to significant lateral and axial movement of the teeth within the pockets. Consequently, movement of a tooth within the pocket contributes to an acceleration of the wear of both the tooth and the pocket. Therefore, a need exits for a tooth and pocket assembly that resists torque applied to the tooth.

### SUMMARY

One aspect of the present invention relates to a tool assembly for attachment to a cutter wheel for use in tree stump removal. The assembly includes a tooth and a pocket. The tooth includes a cutting head and a shank depending from the head. The shank includes a first flat opposite a second flat. The pocket defines opposing wheel and exterior faces. A tooth receiving slot is formed in the wheel face and includes a base. In this regard, the tooth shank defines one of a projection and a recess and the pocket defines the other of the projection and the recess. Upon coupling the tooth shank to the tooth receiving slot, substantially an entirety of a peripheral edge of the projection contacts a wall of the recess to resist a torque applied to the cutting head.

Another aspect of the present invention relates to a cutter wheel assembly rotatably disposed on a tree stump removal machine. The assembly includes a cutter wheel and at least two tool assemblies cooperatively coupled to the cutter wheel. In particular, each tool assembly includes a tooth and a pocket. Each tooth has a cutting head and a shank depending from the cutting head, the shank including a first flat and an opposing second flat. Additionally, each pocket defines opposing wheel and exterior faces. A tooth receiving slot is formed in the wheel face. In this regard, the tooth shank defines one of a projection and a recess and the pocket defines the other of the projection and the recess. Upon coupling, the tooth receiving slot couples with a corresponding one of the teeth shanks with a zero clearance fit between the respective projections and the recesses.

Yet another aspect of the present invention relates to a method of attaching a cutting tooth to a cutter wheel rotatably disposed on a tree stump removal machine. The method includes providing the tooth, where the tooth includes a cutting head and a shank depending from the head. The shank includes a first flat and a second flat. The method additionally includes providing a pocket, where the pocket defines opposing wheel and exterior faces. A tooth receiving slot is formed in the wheel face. The method further includes configuring the tooth shank to define one of a projection and a recess and configuring the pocket to define the other of the projection and the recess. The method further includes snap fitting the projection into the recess to form an assembly such that substantially an entirety of a peripheral edge of the projection contacts a wall of the recess. The method ultimately includes attaching the assembly to the cutter wheel. In this regard, the projection and the recess tightly couple to resist a torque applied to the tooth.

### BRIEF DESCRIPTION OF THE DRAWINGS

FIG. 1 is a perspective view of a prior art cutter wheel assembly;

FIG. 2 is a perspective view of a prior art tool assembly showing a prior art tooth in ghost outline illustrating torque applied to the tooth;

FIG. 3 is a perspective view of a cutter wheel assembly showing tool assemblies according to one embodiment of the present invention;

FIG. 4A is a perspective view of a tooth according to one embodiment of the present invention;

FIG. 4B is a cross-sectional view of the tooth of FIG. 4A;

FIG. 5A is a perspective view of a pocket according to one embodiment of the present invention;

FIG. 5B is a cross-sectional view of the pocket of FIG. 5A;

FIG. 6 is a cross-sectional view of a tool assembly showing a tooth positioned for coupling to a pocket;

FIG. 7 is a perspective view of a tool assembly in an assembled state; and

FIG. 8 is a cross-sectional view of an alternate tool assembly.

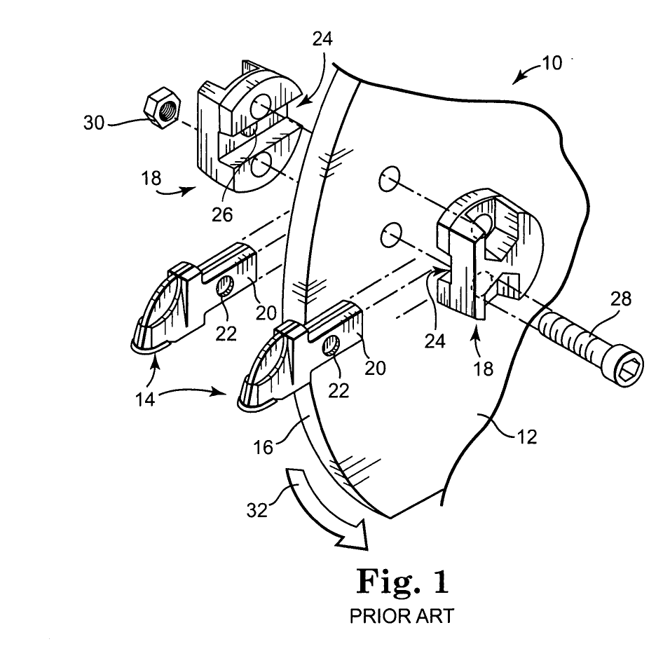

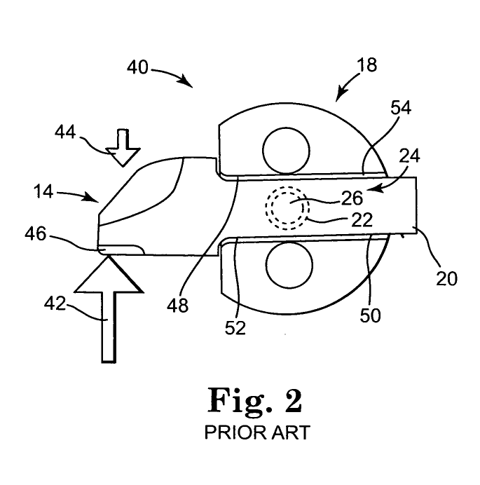

### DETAILED DESCRIPTION

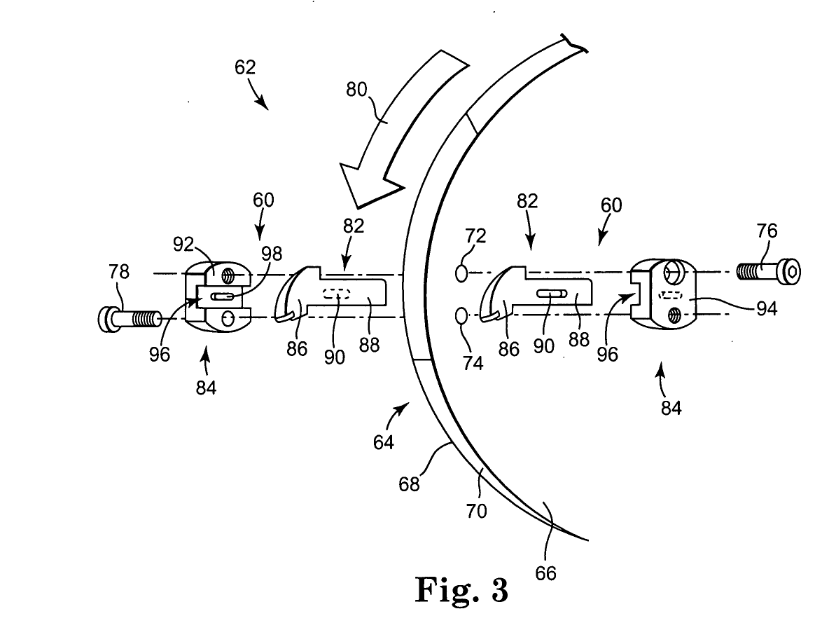

A pair of tool assemblies 60 in accordance with the present invention are shown in FIG. 3 as part of a cutter wheel assembly 62. In general terms, the cutter wheel assembly 62 includes a plurality of the tool assemblies 60 disposed in pairs mounted about a periphery of a cutter wheel 64. For ease of illustration, however, only two of the tool assemblies 60 are shown.

The cutter wheel 64 is generally circular and includes a first face 66 and a second face 68 on either side of a peripheral edge 70. In addition, the cutter wheel 64 includes a multiplicity of the bolt holes 72 and 74 that permit attachment of the plurality of the tool assemblies 60. In one embodiment, the bolt holes 72, 74 are non-threaded through-holes that permit bolts 76, 78 to pass through the cutter wheel 64 as they thread into the tool assemblies 60. In any regard, the cutter wheel 64 is typically formed of a hardened metal, for example hardened steel, and is configured to rotate in one direction as indicated by arrow 80 when powered by an immense horsepower cutting machine (not shown).

Each of the tool assemblies 60 includes a tooth 82 and a pocket 84. In general terms, the tooth 82 includes a cutting head 86 and a shank 88 depending from the cutting head 86. The shank 88 defines a recess 90 formed therein. Additionally, the pocket 84 includes a wheel face 92 (shown for the left pocket 84 in FIG. 3) opposing an exterior face 94 (shown for the right pocket 84 in FIG. 3), and a tooth receiving slot 96 formed in the wheel face 92. In this regard, a projection 98 (shown for the left pocket 84 in FIG. 3) is provided that extends from the tooth receiving slot 96. As described in greater detail below, upon coupling the tooth 82 to the pocket 84, the projection 98 and the recess 90 are configured to tightly couple with a zero clearance fit such that a torque applied to the cutting head 86 is resisted.

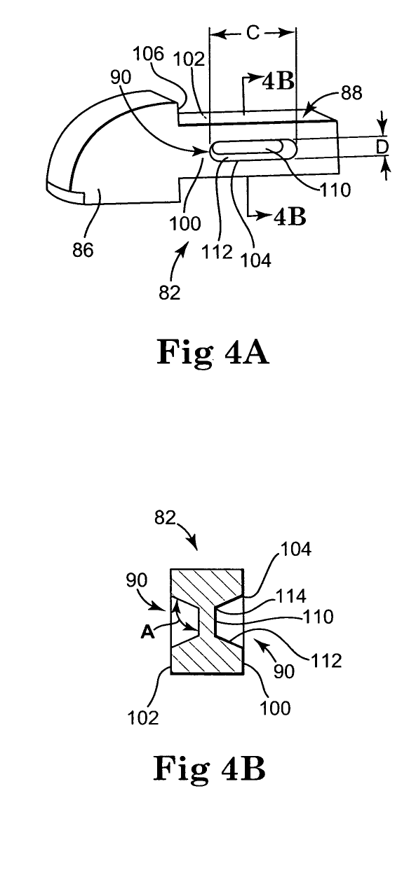

The tooth 82 according to one embodiment of the present invention is illustrated in FIGS. 4A and 4B. Once again, the tooth 82 includes the cutting head 86 and the shank 88. The shank 88 includes a first flat 100 and a second flat 102, with each flat 100, 102 defining one of the recesses 90 (best shown in FIG. 4B). To this end, each recess 90 is defined by an entrance perimeter 104. In addition, the shank 88 depends from a shoulder 106 defined by the cutting head 86. The recess 90 is better understood with reference to FIG. 4B.

In one embodiment, the flats 100, 102 define opposing recesses 90, such the shank 88 is provided with two mirror-image recesses 90. In this regard, each recess 90 is defined by a base 110 and a tapered wall 112 extending upwardly relative to the base 110 and transversely outwardly relative to the base 110 by an angle A. In one embodiment, the tapered wall 112 is positioned relative to the base 110 by an angle A preferably between 2 degrees and 30 degrees, more preferably between 4 degrees and 20 degrees, and most preferably between approximately 5 degrees and approximately 15 degrees. With this structure in mind, each recess 90 is defined by the entrance perimeter 104 and a land perimeter 114. In one embodiment, each of the entrance perimeter 104 and the land perimeter 114 define a shape of a rectangle having rounded ends in longitudinal cross-section. Alternately, and as described below, a wide variety of other shapes are also acceptable. In an alternate embodiment, the land perimeter 114 defines a small radius due to a forging process employed to create the recess 90. The tapered wall 112 is still disposed relative to the base 110 by the angle A, however the small radius of the land perimeter 114 connects between the base 110 and the tapered wall 112. In this regard, the tapered wall 112 is non-linearly connected to the base 110.

The entrance perimeter 104 is sized to accept and accommodate the projection 98 (FIG. 3). Generally, and with reference to FIG. 4A, the entrance perimeter 104 shape is rectangular having rounded ends (as viewed in longitudinal cross-section) and can be described by a length C and a width D. In one embodiment, the length C is approximately 0.650 to approximately 0.675 inch and the width D is approximately 0.300 to approximately 0.325 inch. The length C is selected to be at least twice the size of the width D. In particular, the length C provides a long bearing surface against which the projection 98 can dissipate torque created during a cutting operation. In one embodiment, upon coupling, the tapered wall 112 on either side of the recess 90 contacts the projection 98 along an entirety of the length C to resist torque delivered to the cutting head 86. As noted, the tapered wall 112 extends upwardly relative to the base 110, and as such, the entrance perimeter 104 is dimensioned to be larger than the land perimeter 114. In one embodiment, the land perimeter 114 shape is rectangular having rounded ends with a length of approximately 0.610 to approximately 0.620 inch and a width of approximately 0.260 to approximately 0.270 inch. Alternately, other dimensions are equally acceptable.

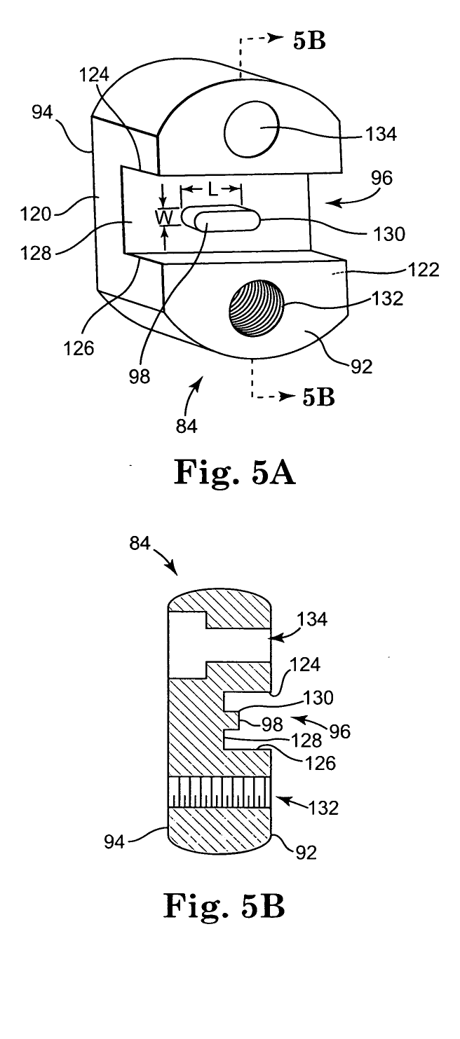

The pocket 84 according to one embodiment of the present invention is illustrated in FIGS. 5A and 5B, and includes the wheel face 92 and the exterior face 94 (FIG. 5B). Further, as shown in FIG. SA, the pocket 84 defines a first edge 120 opposing a second edge 122. The wheel face 92 defines the tooth receiving slot 96 that extends between the edges 120, 122. In this manner, the tooth receiving slot 96 is defined by a first wall 124 and a second wall 126, the walls 124, 126 extending from a base 128. The projection 98 extends from the base 128 and terminates in a peripheral edge 130. Finally, the pocket 84 defines a first bore 132 and a second bore 134 that cooperate with the bolts 76, 78 in securing the pocket 84 to the cutter wheel 64 (FIG. 3).

In one embodiment, the projection 98 is rectangular in shape having rounded ends as viewed in longitudinal cross-section. In particular, the peripheral edge 130 defines a length L and a width W, as shown in FIG. 5A. In one embodiment, the peripheral edge 130 has a width W of approximately 0.275 to approximately 0.300 inch and a length L of approximately 0.625 to approximately 0.650 inch. Alternately, other dimensions are equally acceptable. Additionally, the projection 98 extends a distance away from the base 128, as better illustrated in FIG. 5B.

A cross-sectional view of the pocket 84 according to one embodiment of the present invention is shown in FIG. 5B. The projection 98 is positioned equidistant between the first wall 124 and the second wall 126. In one embodiment, the projection 98 is a nub that does not extend all the way to the wheel face 92. In particular, the projection 98 extends away from the base 128 by a dimension of approximately 0.125 inch to approximately 0.150 inch. Alternately, other dimensions are equally acceptable. Regardless, a height of the projection 98 is less than a depth of the recess 90 (FIG. 4B) such that the peripheral edge 130 of the projection 98 does not touch the base 110 of the recess 90 when assembled.

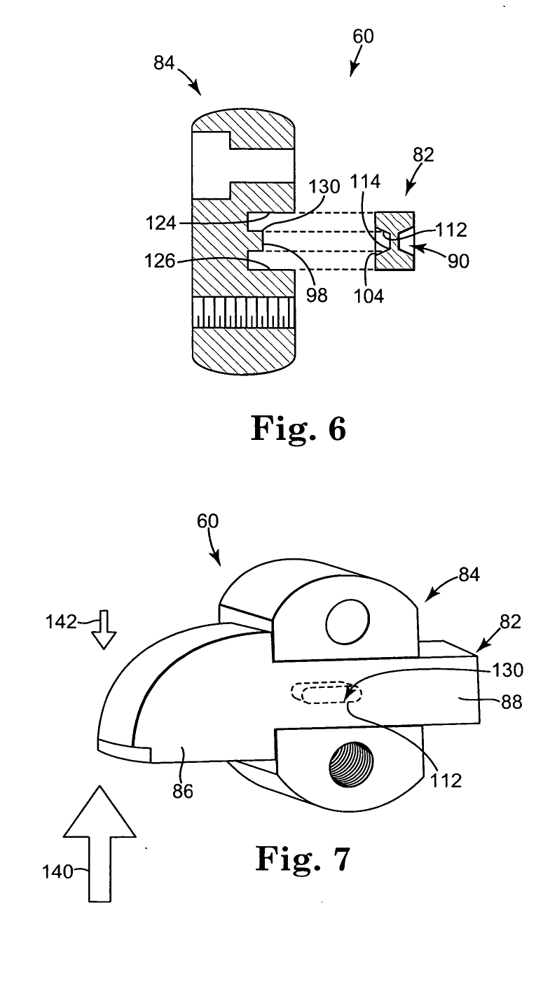

Upon final assembly, the tooth 82 is coupled with the pocket 84 to form the tool assembly 60, as illustrated in the cross-sectional view of FIG. 6. In accordance with the present invention, the tooth 82 and the pocket 84 are configured to couple such that substantially an entirety of the peripheral edge 130 of the projection 98 contacts the tapered wall 112 of the recess 90 to resist a torque applied to the cutting head. As employed herein, substantially an entirety of the peripheral edge 130 contacting the tapered wall 112 of the recess 90 is defined to mean that preferably at least 30% of the peripheral edge 130 contacts the tapered wall 112, more preferably at least 50% of the peripheral edge 130 contacts the tapered wall 112, and most preferably at least 70% of the peripheral edge 130 contacts the tapered wall 112.

In other words, the contact between the peripheral edge 130 of the projection 98 and the tapered wall 112 of the recess 90 forms a snap tight fit. In a preferred embodiment, the tooth 82 couples with the pocket 84 with a zero clearance fit between the peripheral edge 130 and the tapered wall 112. That is to say, the tooth 82 and the pocket 84 mate so tightly together that they can be handled and transported as a single unit without the tooth 82 falling out of the pocket 84. Specifically, the zero clearance fit between the peripheral edge 130 and the tapered wall 112 can be ascertained by the absence of a measurable distance (for example, when employing a machinist's caliper) between the peripheral edge 130 and the tapered wall 112 of the recess 90. In a preferred embodiment, the projection 98 contacts the tapered wall 112 of the recess 90 such that the tooth 82 is inseparable from the pocket 84 under a force equal to the weight of the tooth 82.

The novel tool assembly 60 according to one embodiment of the present invention is shown assembled in FIG. 7. The tooth 82 is coupled to the pocket 84 such that the peripheral edge 130 of the projection 98 contacts the tapered wall 112 of the recess 90. In particular, there is no clearance between the recess 90 of the tooth 82 and the peripheral edge 130 of the projection 98. During use, as the cutting head 86 tears apart a tree stump (not shown) a relatively large torque 140 is imparted to the tooth 82 and transmitted down the shank 88. An opposing force in the form of a countering torque 142 is also imparted to the tooth 82 via the pocket 84 that is otherwise rigidly connected to the cutting wheel 64 (FIG. 3). The countering torque 142 is proportionally smaller than the torque 140, as illustrated in FIG. 7. Together, the torque 140 and the countering torque 142 cyclically stress the cutting head 86 during a stump removal operation. However, in accordance with the present invention, the recess 90 and the projection 98 are configured to couple tightly together with a zero clearance fit (i.e., a snap fit) to resist the cyclical stress imparted to the tooth 82 by the torque 140 and the countering torque 142.

In one embodiment, and with reference to FIGS. 6 and 7, the recess 90 and the projection 98 are centrally positioned within the shank 88 and the slot 96 (FIG. 5A), respectively. In particular, the tooth 82 can be coupled to the pocket 84 such that the shoulder 106 (FIG. 4A) is adjacent to the first edge 120 (FIG. 5A). Alternately, the tooth 82 can be coupled to the pocket 84 such that the shoulder 106 is adjacent to the second edge 122 (FIG. 5A). In any regard, the peripheral edge 130 of the projection 98 contacts the tapered wall 112 such that lateral and axial movement of the tooth 82 within the pocket 84 is nearly eliminated. To this end, the recess 90 and the projection 98 could define various forms other than the rectangle having rounded ends described herein and still couple together with a zero clearance fit. For example, the shape of the recess 90 and the projection 98 are generally complementary and can be oblong, ellipsoidal, or square in cross-section and, when configured to couple with a zero clearance fit, resist torque applied to the cutting head 86.

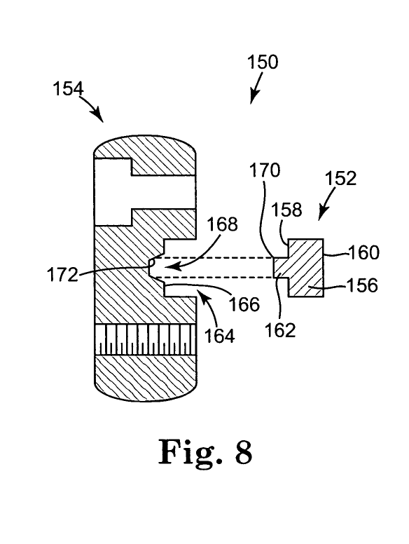

An alternate tool assembly 150 is illustrated in FIG. 8. The tool assembly 150 includes a tooth 152 and a pocket 154. As with previous embodiments, the tooth 152 includes a cutting head (not shown) and a shank 156. The shank 156 defines a first flat 158 and a second flat 160. However, with the embodiment of FIG. 8, the tooth 152 further includes a projection 162 extending from the first flat 158. Alternatively, a second, identical projection (not shown) can be provided, extending from the second flat 160. As with previous embodiments, the pocket 154 defines a tooth receiving slot 164 having a base 166. In addition, with the embodiment of FIG. 8, a recess 168 is further defined by the pocket 154, extending inwardly from the base 166. The projection 162 and the recess 168 can take any of the forms previously described for the respective projection 98 (FIG. SA) and the recess 90 (FIG. 4A). In particular, the projection 162 defines a peripheral edge 170; whereas the recess 168 is defined, in part, by a tapered wall 172. In one embodiment, the tooth 152 is coupled to the pocket 154 by engaging the shank 156 with the tooth receiving slot 164. In a preferred embodiment, upon coupling, substantially an entirety of the peripheral edge 170 contacts the tapered wall 172 to resist a torque applied to the cutting head during a stump cutting operation.

Although specific embodiments have been illustrated and described herein, it will be appreciated by those of ordinary skill in the art after reading and understanding this disclosure that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. A tool assembly for attachment to a cutter wheel for use in tree stump removal, the assembly comprising:
a tooth including a cutting head and a shank depending from the head, the shank including a first flat opposite a second flat; and
a pocket including:
opposing wheel and exterior faces, and
a tooth receiving slot formed in the wheel face and including a base;
wherein the tooth shank defines one of a projection and a recess and the pocket defines the other of the projection and the recess;
further wherein upon coupling the tooth shank to the tooth receiving slot, substantially an entirety of a peripheral edge of the projection contacts a wall of the recess to resist a torque applied to the cutting head.

2. The tool assembly of claim 1, wherein at least one of the flats define the recess and the pocket defines the projection, the projection extending from the base of the tooth receiving slot.

3. The tool assembly of claim 1, wherein the tooth couples to the pocket with a zero clearance fit between the projection and the recess.

4. The tool assembly of claim 3, wherein the zero clearance fit is a snap fit.

5. The tool assembly of claim 1, wherein the recess is further defined by a base, the wall extending from the base of the recess at an angle in the range of 2 degrees to 30 degrees.

6. The tool assembly of claim 1, wherein the recess and the projection are configured such that upon assembly, axial movement of the tooth within the pocket is eliminated.

7. The tool assembly of claim 1, wherein the recess and the projection are configured such that upon assembly, lateral movement of the tooth within the pocket is eliminated.

8. The tool assembly of claim 1, wherein the projection contacts the wall of the recess such that the tooth is inseparable from the pocket under a force equal to a weight of the tooth.

9. The tool assembly of claim 1, wherein the projection defines a length and a width in longitudinal cross-section, the length selected to be at least twice the width.

10. A cutter wheel assembly rotatably disposed on a tree stump removal machine, the assembly comprising:
a cutter wheel; and
at least two tool assemblies cooperatively coupled to the cutter wheel, each tool assembly including:
a tooth having a cutting head and a shank depending from the cutting head, the shank including a first flat opposing a second flat, and
a pocket defining opposing wheel and exterior faces, and a tooth receiving slot formed in the wheel face;
wherein each tooth shank defines one of a projection and a recess and each pocket defines the other of the projection and the recess;
further wherein each tooth receiving slot couples with a corresponding one of the teeth shanks with a zero clearance fit between the respective projections and the recesses.

11. The cutter wheel assembly of claim 10, wherein at least one of the flats define the recess and the pocket defines the projection, the projection extending from a base of the tooth receiving slot.

12. A method of attaching a cutting tooth to a cutter wheel rotatably disposed on a tree stump removal machine, the method comprising:
providing the tooth, the tooth including a cutting head and a shank depending from the head, the shank including a first flat and a second flat;
providing a pocket, the pocket defining opposing wheel and exterior faces, a tooth receiving slot formed in the wheel face;
configuring the tooth shank to define one of a projection and a recess;
configuring the pocket to define the other of the projection and the recess;
snap fitting the projection into the recess to form an assembly such that substantially an entirety of a peripheral edge of the projection contacts a wall of the recess; and
attaching the assembly to the cutter wheel;
wherein the projection and the recess tightly couple to resist a torque applied to the tooth.

13. The method of claim 12, wherein configuring the tooth shank includes configuring at least one of the flats to define the recess and configuring the pocket includes configuring the pocket to define the projection, the projection extending from a base of the tooth receiving slot.
